(19) United States
(12) Patent Application Publication
(10) Pub. No.: US 2016/0335343 A1
(43) Pub. Date: Nov. 17, 2016

(54) METHOD AND APPARATUS FOR UTILIZING AGRO-FOOD PRODUCT HIERARCHICAL TAXONOMY

(71) Applicant: Culios Holding B.V., Putten (NL)

(72) Inventors: Hendrikus LUITJES, Putten (NL); Julius Lars HULZEBOS, Wageningen (NL)

(21) Appl. No.: 14/710,089

(22) Filed: May 12, 2015

(51) Int. Cl. G06F 17/30

(52) U.S. Cl. CPC G06F 17/30675; G06F 17/30625

(57) ABSTRACT

Method and apparatus for determining relevant parts of an input phrase having a plurality of text elements. A first data structure is provided having a hierarchical taxonomy of a group of terms from the agro-food domain, and a second data structure including a plurality of product related item identifications. Keywords are distilled from the input phrase by matching terms from the first data structure to the plurality of text elements of the input phrase, and providing a certainty score for each associated distillated keyword. The distillated keywords are prioritized into prioritized keywords using the hierarchical structure of the matching terms in the first data structure. The prioritized keywords having the highest certainty score are then matched with the plurality of product related item identifications from the second data structure.

### FIELD OF THE INVENTION

The present invention relates to a method and apparatus for distilling and ranking meaningful terms in an input phrase.

### PRIOR ART

American patent publication US2014/0324740 discloses an ontology-based attribute extraction method from product descriptions, i.e. an unstructured document associated with a product. A structured list of attributes and corresponding values are extracted and stored, and used for later comparison in e.g. search queries or product comparisons.

### SUMMARY OF THE INVENTION

The present invention seeks to provide an improved method and apparatus for distilling and ranking meaningful terms in an input phrase, especially suited for the agro-food domain.

According to the present invention, a method is provided, for determining relevant parts of an input phrase having a plurality of text elements (i.e. text, in plain language, e.g. obtained via voice recognition or keyboard input). The method comprises providing a first data structure comprising a hierarchical taxonomy of a group of terms from the agro-food domain. I.e. a plurality of words from the agro-food domain, in levels of hierarchical taxonomy and with mutual relations, such as synonyms. Further, a second data structure is provided comprising a plurality of product related item identifications. The method further comprises:
distillate keywords from the input phrase by matching terms from the first data structure to the plurality of text elements of the input phrase, and providing a certainty score for each associated distillated keyword;
prioritize the distillated keywords into prioritized keywords using the hierarchical structure of the matching terms in the first data structure; and
match the prioritized keywords having the highest certainty score with the plurality of product related item identifications from the second data structure.

In a further aspect of the present invention, an apparatus is provided for obtaining relevant text from an input phrase having a plurality of text elements, the apparatus comprising a first storage unit in which a first data structure is stored, the first database comprising a hierarchical taxonomy of a group of terms from the agro-food domain, a second storage unit in which a second data structure is stored, the second data structure comprising a plurality of product related item identifications,
a processing unit connected to both the first storage unit, the second storage unit, and an input unit for receiving the input phrase, wherein the processing unit is arranged to receive the input phrase from the input unit, and to access the first storage unit to distillate keywords from the input phrase by matching terms from the first data structure to the plurality of text elements of the input phrase, and providing a certainty score for each associated distillated keyword, and to prioritize the distillated keywords into prioritized keywords using the hierarchical taxonomy of the matching terms in the first data structure, and furthermore to access the second data structure to match the prioritized keywords having the highest certainty score with the plurality of product related item identifications from the second data structure. Such an apparatus may be implemented on a general purpose computer system having the proper input system to receive the input phrase, such as a voice recognition system, input keyboard or touch screen.

In an even further aspect, the present invention may be embodied in a computer program, e.g. in the form of a non-transitory computer-readable medium with instructions stored thereon, that when executed by a processor, perform the steps of determining relevant parts of an input phrase having a plurality of text elements,
providing a first data structure comprising a hierarchical taxonomy of a group of terms from the agro-food domain and a second data structure comprising a plurality of product related item identifications,
distillating keywords from the input phrase by matching terms from the first data structure to the plurality of text elements of the input phrase, and providing a certainty score for each associated distillated keyword, prioritizing the distillated keywords into prioritized keywords using the hierarchical structure of the matching terms in the first data structure; and matching the prioritized keywords having the highest certainty score with the plurality of product related item identifications from the second data structure.

### SHORT DESCRIPTION OF DRAWINGS

The present invention will be discussed in more detail below, using a number of exemplary embodiments, with reference to the attached drawings, in which

FIG. 1 shows a flow chart of a method embodiment of the present invention;

FIG. 2 shows a schematic view of a food product hierarchical taxonomy; and

FIG. 3 shows a schematic block diagram of an apparatus according to an embodiment of the present invention.

### DETAILED DESCRIPTION OF EXEMPLARY EMBODIMENTS

The present invention relates to processing and application of text processing in a specific domain, such as agro-food technology. By proper processing of an input text (received e.g. via direct keyboard input or a voice recognition method), the meaningful and useful terms of the input text can be extracted and matched to e.g. a limited group of products. Text input may be processed in order to provide a shopping list, i.e. the input text is distilled and prioritized to provide only meaningful terms in the context of agro-food products, which terms can then be matched to an assortment (limited group) of products in a grocery store for automatically providing a shopping list.

Modern day text input can be implemented in many ways, such as typing (parts of) keywords, or other keyboard based input methods (e.g. ‘swiping’ on a touch screen). Also voice recognition techniques are much more used nowadays. These novel techniques have in common that a much greater part of input data to a processing system is in natural language (as if talking to another person) making the text recognition a much more difficult task. The present invention embodiments may thus be used as part of a conversational interface for many different applications.

The present invention embodiments provide a solution which is especially useful in interpreting an input text or input phrase to obtain meaningful terms (or keywords) therein. Interpretation may comprise term distillation in a first step and prioritization in a second step. According to a first embodiment of the present invention a method is provided for determining relevant parts of an input phrase having a plurality of text elements. The method comprises providing a first data structure comprising a hierarchical taxonomy structure of a group of terms from the agro-food domain and a second data structure comprising a plurality of product related item identifications.

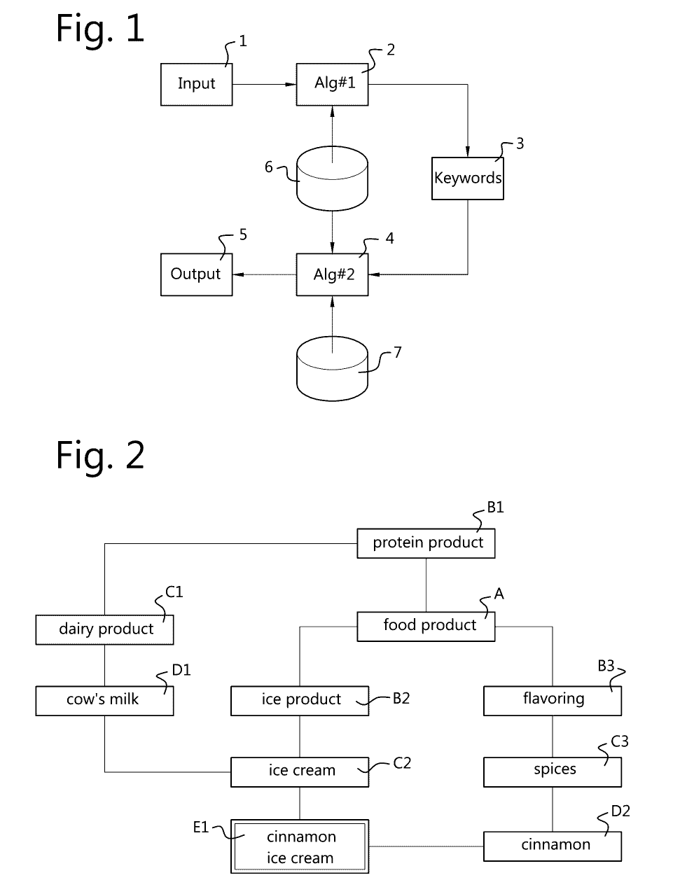

The method further comprises (as also shown in the flow chart of FIG. 1 described below):
distillate keywords from the input phrase by matching terms from the first data structure to the plurality of text elements of the input phrase, and providing a certainty score for each associated distillated keyword;
prioritize the distillated keywords into prioritized keywords using the hierarchical taxonomy of the matching terms in the first data structure; and
match the prioritized keywords having the more significant score with the plurality of product related item identifications from the second data structure.

With respect to the step of prioritize it is noted that e.g. in the word bacon pancake, the term bacon has a lower significance than pancake, as it is a protein based product, as compared to a carbohydrate based product.

This general aspect of the present invention is further explained with reference to the flow diagram as shown in FIG. 1. In block 1, the input phrase is obtained having a plurality of text elements. This can be accomplished e.g. using a direct (typed) input from a keyboard, or using voice recognition on received spoken text. Also other types of input can be envisaged, e.g. selection of text sentences or fragments in a computer environment (e.g. using a mouse or touch screen input).

This input phrase is the received by a first algorithm (block 2) implementing the steps of distillate keywords from the input phrase and prioritize the distilled keywords, using information stored in a first data structure 6 storing the hierarchical taxonomy structure of a group of terms from the agro-food domain. The hierarchical taxonomy structure comprises a group or large number of words from e.g. the agro-food domain, in levels of hierarchical taxonomy and with mutual relations such as synonyms, see also the description with reference to FIG. 2 below. The extracted keywords (block 3, so the output of the first algorithm) is then subsequently input to a second algorithm block 4 for the further processing step of matching the prioritized keywords with plurality of product related item identifications stored in a second data structure 7. The product related item identifications as stored in the second data structure 7 are e.g. a (limited) number of products available in a grocery, or recipes for preparing a dish or complete meal. The product related item identifications can also comprise further texts, e.g. health related terms, for sale items, coupons, etc. The output of this algorithm block 4 then provides an output 5, e.g. in the form of a single matching product identification.

Of course, the obtained information can be further processed, even using further input from a user. E.g. the composition of a family can be used to provide information on the needed amounts of certain products identified for a recipe.

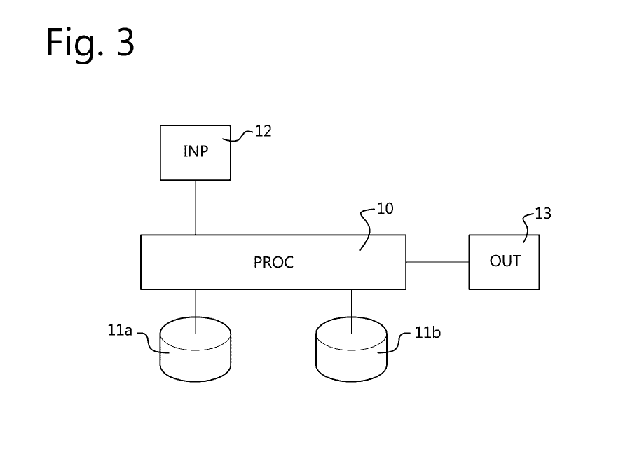

The invention embodiments can be seen as a computer program stored on a non-transitory computer-readable medium with instructions stored thereon, that when executed by a processor, perform the steps of the present invention method embodiments. Furthermore, the present invention embodiments can be seen as an apparatus implementing the present invention method embodiments, e.g. an apparatus of which a schematic diagram is shown in FIG. 3. A processor 10 is connected and able to exchange data with a first storage unit 11a (e.g. for storing the first data structure 6) and a second storage unit 11b (e.g. for storing the second data structure 7). It is noted that e.g. also the first and second data structure 6, 7 can be stored on a single storage unit 11a, 11b, in which case the other storage unit 11b, 11a is e.g. used for storing program data or intermediate data. The apparatus further comprises an input unit 12 connected to the processor 10 and an output unit connected to the processor 10.

The apparatus according to the present invention embodiments could thus have the form of an apparatus for obtaining relevant text from an input phrase having a plurality of text elements, the apparatus comprising a first storage unit 11a in which a first data structure 6 is stored, the first data structure 6 comprising a hierarchical taxonomy structure of a group of terms from the agro-food domain, a second storage unit 11b in which a second data structure 7 is stored, the second data structure 7 comprising a plurality of product related item identifications, and a processing unit 10 connected to both the first storage unit 11a, the second storage unit 11b, and an input unit 12 for receiving the input phrase. The processing unit 10 is arranged to receive the input phrase from the input unit 12, and to access the first storage unit 11a to distillate keywords from the input phrase by matching terms from the first data structure 6 to the plurality of text elements of the input phrase, and providing a certainty score for each associated distillated keyword, and to prioritize the distillated keywords into prioritized keywords using the hierarchical taxonomy of the matching terms in the first data structure 6. Furthermore the processing unit 10 is arranged to access the second data structure 7 to match the prioritized keywords having the most significant score with the plurality of product related item identifications from the second data structure 7.

In short, the input can be any type of text input, like a spoken sentence such as ‘put one bag of chips with ketchup flavor on my shopping list’. The present invention embodiments then determines and ranks the meaningful agro-food terms in this sentence (‘chips’ and ‘ketchup’). These terms can then be used to provide a best match in the second data structure 7 of product items, e.g. ‘Lay’s ketchup chips, 255 grams. It is to be noted that both the first and second data structure 6, 7 have a hierarchical taxonomy allowing to distillate and rank meaningful terms (in this case in the agro-food domain). Matching can then be performed easily and effectively to find a correct product by simply matching the meaningful terms only. Possibly the matching output is a (ordered) list of possible matches, which can then be easily presented to a user for quick selection of the desired product.

It is noted that an identified term can also be a negative term (or negative composition of terms, e.g. in the input phrase ‘I'd like some spaghetti without meat’ the term ‘without meat’ would be a negative term. This can be accounted for in the further processing of all relevant identified terms, e.g. by further labeling an identified term as a like or dislike.

It is important to note that using the present invention embodiments, it is not the hierarchical taxonomy of the first and second data structure 6, 7 which determines the output of the method, but the distilled, prioritized and matched terms. This allows even to have synonyms, wrongly spelled words or e.g. language/dialect differences in the input phrase and still obtaining the correct matching product from the second data structure 7.

The first data structure 6 can be seen as a hierarchical taxonomy agro-food network of terms that are used in the agro-food domain. This lessens the burden for the data structure capacity, as not an entire lexicon is needed. The first data structure 6 has a hierarchical taxonomy structure, based on at least two of the group of features comprising: chemical structure; physical shape; agricultural terms; flavoring. The chemical structure in an agro-food domain can e.g. be protein based products and carbohydrate products, the physical shape can e.g. be beverage and ice, the agricultural terms can e.g. be vegetables and fruit, and the flavorings can e.g. be spices and herbs. The hierarchical taxonomy in the first data structure 6 has thousands of terms from the agro-food domain including their mutual relations. As a result the first algorithm (block 2 in FIG. 1) can ‘know’ synonyms for an extracted term, but also whether possible relations exist with other terms.

In FIG. 2, an example of a part of such a hierarchical taxonomy is explained for the food term ‘cinnamon ice cream’ E1. In short, this term is described in the hierarchical taxonomy as an ice product B2 (more specific ice cream C2), which comprises cow's milk (D1, being a dairy product C1, in its turn being a protein product B1) and cinnamon D2, being a flavoring B3 from the class of spices C3.

As mentioned above, the method or apparatus according to the present invention embodiments, receives information in the form of input (text) phrases related to food, and from the input phrases meaningful terms are distilled as a first step by comparing the input phrase (or text string) to terms in the first data structure 6. Related to this matching process is a determination of a certainty factor related to the associated term. This certainty factor is used to rank the distilled meaningful terms.

Especially in the case of concatenated terms, or terms being a combination of two or even more separate terms, special care has to be taken to get the proper result. Concatenated terms are much used dependent on the language (e.g. Dutch and German have many concatenated terms, whereas English has much more combinations of separate but associated terms).

In an embodiment, the step of matching terms from the first data structure 6 to the text elements of the input phrase further comprises matching terms from the first data structure 6 to parts of the text elements, and providing a certainty score with a lower value to the associated separate matching terms from the first data structure 6 as compared to the certainty score of the concatenated matching terms. This rarely occurs in English, but is quite common in e.g. the Dutch language: ‘bonensoep’ is a concatenation of the separate terms ‘bonen’ and ‘soep’. According to this embodiment, the terms ‘bonen’ and ‘soep’ will both get a lower certainty score as the concatenated term ‘bonensoep’ (if all these terms are found in the first data structure 6).

In a further embodiment, a similar rule is applied but now for a meaningful term having a combination of two or more terms, which in themselves also are meaningful terms. The step of matching terms from the first data structure 6 to the text elements of the input phrase then further comprises matching terms from the first data structure to adjacent text elements (or e.g. part-terms separated by a space), and providing a certainty score with a higher value to the associated combination of matching terms from the first data structure as compared to the certainty scores of the associated separate matching terms. E.g. the meaningful terms in an input phrase ‘witte-bonensoep’ would be ‘witte bonen’ and ‘ soep’. The term ‘witte bonen’ will get a higher certainty score then the term ‘soep’ as it is a composed term. In order to more accurately and properly analyze the input phrase, in a further optional step all punctuation marks in the input phrase are replaced by spaces.

In order to be able to perform a proper matching of distilled terms to the product list in the second data structure 7, first the distilled meaningful terms are ranked or prioritized. For this the hierarchical taxonomy of the first data structure 6 is used. First the main structure of the agro-food item is determined from the input phrase. It has been found that at the highest level, e.g. the carbohydrate terms should be ranked before the protein terms. E.g. in the case of the distilled term ‘bacon pancake’ the main item is ‘pancake’, and the addition to that main item is ‘bacon’. The prioritized keywords would then be 1. ‘pancake’ and 2. ‘bacon’. Even if the input phrase would be ‘I would like bacon on my pancake’ the matched keywords would still be in the same order. Thus, in a further embodiment, the hierarchical taxonomy comprises the following ordered features: chemical structure; physical shape; agricultural terms; flavoring.

If the input phrase is e.g. ‘I would like to have a bit of meat such as a steak’, the meaningful terms that would be distilled would be ‘meat’ and ‘steak’. In the hierarchical taxonomy of the first data structure 6 these terms are associated or linked, and both are protein products, and would end up with the same priority level. The term ‘steak’ would be in a deeper layer in the hierarchical taxonomy of the first data structure 6 than the term ‘meat’. To make a proper ranking, a further embodiment is provided, wherein if prioritizing the distilled keywords results in two or more prioritized keywords having a same priority level, a depth of term level is determined of the associated term in the hierarchical taxonomy in the first data structure 6, and the prioritized keyword having the deepest depth of term level is ranked before the prioritized keyword having a less deep depth of term level. In this case, the term ‘steak’ would thus be held more meaningful than the term ‘meat’.

To further widen the possible applications of the present invention embodiments, the specific domain can be widened, e.g. to include non-food items in addition to agro-food items, e.g. in relation to the product domain of a grocery shop.

An example is e.g. the term ‘lemon detergent’ which has an agro-food domain term ‘lemon’ but should be associated with a product group different from fruits. In most cases, it has proven that the non-food related term is the more meaningful term in such cases. Thus, in a further embodiment, the first data structure 6 further comprises terms from a non-food domain, and the second data structure 7 further comprises non-food product related item identifications. In an even further embodiment, the non-food domain terms are classified as highest level priority terms. In such an augmented domain, the priority schedule then may be 1. non-food; 2. carbohydrate product; 3. protein product; 4. physical shape identification; 5. vegetable; 6. fruit; 7. flavoring. It is noted that in this example, the agricultural terms ‘vegetable’ and ‘fruit’ are explicitly mentioned and used in the priority schedule.

Ranking of the meaningful terms in an input phrase is thus performed first on basis of a priority level, then on the certainty level, and finally on the depth of term level in the first data structure 6. Examples given below will further clarify this. A consumer enters a phrase Put one bag of paprika chips on the grocery list.

The prioritized meaningful agro-food terms are 1. ‘chips’ and 2. ‘paprika’. If in the second data structure a product is included comprising a brand name, such as ‘1 The Best chips paprika 120 gram’ then prioritization would render the same result, and the input phrase will be matched to that product item. A consumer enters a phrase ‘I'd like a tonic with lemon’, which would result in the prioritized list 1. ‘Tonic’ and 2. ‘Lemon’.

An input phrase entered into the present invention apparatus is ‘Put meat balls made of chicken and turkey in Italian style with mozzarella cheese on my grocery list’, the prioritized meaningful terms would be 1. ‘Meat balls’, 2. ‘Chicken’, 3. ‘Turkey’, 4. ‘Mozzarella’, 5. ‘Cheese’.

A wish is entered as input phrase ‘I crave for a pizza with cheese and onion’, which would result in the meaningful terms 1. ‘Pizza’, 2. ‘Cheese’, 3. ‘Onion’. An input sentence could be ‘what is this unfamiliar product with the name ‘Aidell's chicken and apple smoked sausage 12 oz.’ which would provide the meaningful terms 1. ‘Smoked sausage’, 2. ‘Chicken’, 3. ‘Apple’. Using these meaningful terms, it would even be possible to find an alternative product in the second data structure 7.

A consumer enters ‘I want olive oil with basil’, which provides the prioritized list 1. ‘Olive oil’, 2. ‘Basil’.

An input phrase is entered as ‘I'm looking for a candle with lavender scent’, which would result in the prioritized meaningful terms 1. ‘Candle’, 2. ‘Lavender’.

The obtained list of meaningful terms has an order of the terms, which is important in matching the terms with the product related item identification in the second data structure 7. As the list is ordered, the matching process can be more efficient (in terms of resource and time usage). Also the obtained result is usual more specific, which when the present invention embodiment is used in an e-commerce environment, might e.g. result in a better and more useful presentation of related advertisements. Or it might result in a more efficient composition of a grocery list (e.g. in an online app). In all embodiments, it has been found that there is no need whatsoever to look at any grammatical context of the terms in the input phrase, as the result of the prioritized list of terms is always the same, independent of the order in which the meaningful terms are present in the input phrase.

In a further embodiment, the matched product related item identifications are used to compose a grocery list, e.g. an online grocery list for a web shop.

Alternatively, the matched product related item identifications are used to determine suggested additions, e.g. for obtaining a complete meal having sufficient nutritional elements or for suggesting an additional item augmenting the meal.

In an even further embodiment the matched product related item identifications are used to select an advertisement from a group of advertisements.

The present invention embodiments have been described above with reference to a number of exemplary embodiments as shown in the drawings. Modifications and alternative implementations of some parts or elements are possible, and are included in the scope of protection as defined in the appended claims.

1. A method for determining relevant parts of an input phrase having a plurality of text elements,
the method comprising providing a first data structure comprising a hierarchical taxonomy of a group of terms from the agro-food domain; and
a second data structure comprising a plurality of product related item identifications,
the method further comprising:
distillate keywords from the input phrase by matching terms from the first data structure to the plurality of text elements of the input phrase, and providing a certainty score for each associated distillated keyword;
prioritize the distillated keywords into prioritized keywords using the hierarchical structure of the matching terms in the first data structure; and
match the prioritized keywords having the highest certainty score with the plurality of product related item identifications from the second data structure.

2. The method of claim 1, wherein if prioritizing the distilled keywords results in two or more prioritized keywords having a same priority level, a depth of term level is determined of the associated term in the hierarchical taxonomy in the first data structure,
and the prioritized keyword having the deepest depth of term level is ranked before the prioritized keyword having a less deep depth of term level.

3. The method of claim 1, wherein matching terms from the first data structure to the text elements of the input phrase further comprises matching terms from the first data structure to parts of the text elements, and providing a certainty score with a lower value to the associated matching terms from the first data structure as compared to the certainty score of the concatenated matching terms.

4. The method of claim 1, wherein matching terms from the first data structure to the text elements of the input phrase further comprises matching terms from the first data structure to adjacent text elements, and providing a certainty score with a higher value to the associated combination of matching terms from the first data structure as compared to the certainty scores of the associated separate matching terms.

5. The method of claim 1, wherein the hierarchical taxonomy is based on at least two of the group of features comprising: chemical structure; physical shape; agricultural terms; flavoring.

6. The method of claim 5, wherein the hierarchical taxonomy comprises the following ordered features:
chemical structure; physical shape; agricultural terms; flavoring.

7. The method of claim 1, wherein the first data structure further comprises terms from a non-food domain, and the second data structure further comprises non-food product related item identifications.

8. The method of claim 7, wherein the non-food domain terms are classified as highest level priority terms.

9. The method of claim 1, wherein the matched product related item identifications are used to compose a grocery list.

10. The method of claim 1, wherein the matched product related item identifications are used to determine suggested additions.

11. The method of claim 1, wherein the matched product related item identifications are used to select an advertisement from a group of advertisements.

12. The method of claim 1, wherein the input phrase is obtained by voice recognition for a conversational interface application.

13. Apparatus for obtaining relevant text from an input phrase having a plurality of text elements,
the apparatus comprising a first storage unit in which a first data structure is stored, the first database comprising a hierarchical taxonomy of a group of terms from the agro-food domain,
a second storage unit in which a second data structure is stored, the second data structure comprising a plurality of product related item identifications,
a processing unit connected to both the first storage unit, the second storage unit, and an input unit for receiving the input phrase,
wherein the processing unit is arranged to receive the input phrase from the input unit, and to access the first storage unit to distillate keywords from the input phrase by matching terms from the first data structure to the plurality of text elements of the input phrase, and providing a certainty score for each associated distillated keyword, and to
prioritize the distillated keywords into prioritized keywords using the hierarchical taxonomy of the matching terms in the first data structure,
and furthermore to access the second data structure to match the prioritized keywords having the highest certainty score with the plurality of product related item identifications from the second data structure.

14. The apparatus of claim 13, wherein the processing unit is further arranged to determine a depth of term level of the associated term in the hierarchical taxonomy in the first data structure if prioritizing the distilled keywords results in two or more prioritized keywords having a same priority level, and to rank the prioritized keyword having the deepest depth of term level before the prioritized keyword having a less deep depth of term level.

15. The apparatus of claim 13, wherein the processing unit is further arranged to match terms from the first data structure to parts of the text elements, and to provide a certainty score with a lower value to the associated matching terms from the first data structure as compared to the certainty score of the concatenated matching terms.

16. The apparatus of claim 13, wherein the processing unit is further arranged to match terms from the first data structure to adjacent text elements, and to provide a certainty score with a higher value to the associated combination of matching terms from the first data structure as compared to the certainty scores of the associated separate matching terms.

17. The apparatus of claim 13, wherein the hierarchical taxonomy is based on at least two of the group of features comprising: chemical structure; physical shape; agricultural terms; flavouring.

18. The apparatus of claim 17, wherein the hierarchical taxonomy comprises the following ordered features:
chemical structure; physical shape; agricultural terms; flavouring.

19. The apparatus of claim 13, wherein the first data structure further comprises terms from a non-food domain, and the second data structure further comprises non-food product related item identifications.

20. The apparatus of claim 19, wherein the non-food domain terms are classified as highest level priority terms.

21. The apparatus of claim 13, further comprising a voice recognition unit in communication with the processing unit.

22. A non-transitory computer-readable medium with instructions stored thereon, that when executed by a processor, perform the steps of:
determining relevant parts of an input phrase having a plurality of text elements,
providing a first data structure comprising a hierarchical taxonomy of a group of terms from the agro-food domain and a second data structure comprising a plurality of product related item identifications,
distillating keywords from the input phrase by matching terms from the first data structure to the plurality of text elements of the input phrase, and providing a certainty score for each associated distillated keyword;
prioritizing the distillated keywords into prioritized keywords using the hierarchical structure of the matching terms in the first data structure; and
matching the prioritized keywords having the highest certainty score with the plurality of product related item identifications from the second data structure.

23. The medium of claim 22, wherein if prioritizing the distilled keywords results in two or more prioritized keywords having a same priority level, a depth of term level is determined of the associated term in the hierarchical taxonomy in the first data structure,
and the prioritized keyword having the deepest depth of term level is ranked before the prioritized keyword having a less deep depth of term level.

24. The medium of claim 22, wherein matching terms from the first data structure to the text elements of the input phrase further comprises matching terms from the first data structure to parts of the text elements, and providing a certainty score with a lower value to the associated matching terms from the first data structure as compared to the certainty score of the concatenated matching terms.

25. The medium of claim 22, wherein matching terms from the first data structure to the text elements of the input phrase further comprises matching terms from the first data structure to adjacent text elements, and providing a certainty score with a higher value to the associated combination of matching terms from the first data structure as compared to the certainty scores of the associated separate matching terms.

26. The medium of claim 22, wherein the hierarchical taxonomy is based on at least two of the group of features comprising: chemical structure; physical shape; agricultural terms; flavoring.

27. The medium of claim 26, wherein the hierarchical taxonomy comprises the following ordered features:
chemical structure; physical shape; agricultural terms; flavoring.

28. The medium of claim 22, wherein the first data structure further comprises terms from a non-food domain, and the second data structure further comprises non-food product related item identifications.

29. The medium of claim 28, wherein the non-food domain terms are classified as highest level priority terms.

30. The medium of claim 22, wherein the matched product related item identifications are used to determine suggested additions.

31. The medium of claim 22, wherein the input phrase is obtained by voice recognition for a conversational interface application.
